(19) United States
(12) Patent Application Publication
(10) Pub. No.: US 2016/0225392 A1
(43) Pub. Date: Aug. 4, 2016

(54) RECORDING HEAD, MAGNETIC RECORDING DEVICE COMPRISING RECORDING HEAD AND METHOD OF MANUFACTURING RECORDING HEAD

(71) Applicant: Kabushiki Kaisha Toshiba, Tokyo (JP)

(72) Inventors: Akihiko Takeo, Kokubunji Tokyo (JP); Tomomi Funayama, Fuchu Tokyo (JP); Yusuke Tomoda, Zama Kanagawa (JP)

(21) Appl. No.: 15/059,869

(22) Filed: Mar. 3, 2016

Related U.S. Application Data
(63) Continuation of application No. 14/800,295, filed on Jul. 15, 2015.

(30) Foreign Application Priority Data
Jan. 30, 2015 (JP) 2015-017165

(51) Int. Cl. G11B 5/455; G11B 5/127

(52) U.S. Cl. CPC G11B 5/455; G11B 5/1272

(57) ABSTRACT

According to one embodiment, a recording head includes a recoding magnetic pole which applies a recording magnetic field, a write shield which faces the recording magnetic pole across a recording gap, and a spin-torque oscillator provided in the recording gap between the recording magnetic pole and the write shield. The spin-torque oscillator is physically and/or magnetically destroyed and has resistance greater than or equal to a predetermined value.

### CROSS-REFERENCE TO RELATED APPLICATIONS

This application is a continuation of applicatoin Ser. No. 14/800,295, filed Jul. 15, 2015 and is based upon and claims the benefit of priority from Japanese Patent Application No. 2015-017165, filed Jan. 30, 2015, the entire contents of which are incorporated herein by reference.

### FIELD

Embodiments described herein relate generally to a recording head comprising a high-frequency oscillator, a magnetic recording device using the recording head, and a method of manufacturing the recording head.

### BACKGROUND

As a disk device, for example, a magnetic disk device comprises a magnetic disk provided in a case, a spindle motor which supports and rotates the magnetic disk, and a magnetic head which reads/writes data with respect to the magnetic disk.

A microwave-assisted recording magnetic head has recently been suggested. In this magnetic head, to improve the recording density, a spin-torque oscillator is provided as a microwave oscillator near the main magnetic pole of the magnetic head. By the spin-torque oscillator, a high-frequency magnetic field (microwave) is applied to the magnetic recording layer of the magnetic disk. The microwave-assisted recording has an advantage in its capability to record data on a recording medium having a high magnetic anisotropy compared to the conventional technique if the spin-torque oscillator radiates sufficiently strong microwaves. However, the microwave-assisted recording has an issue in which the characteristics of the spin-torque oscillator occasionally become uneven. For stable mass-production, the quality of the spin-torque oscillator needs to be improved.

The spin-torque oscillator is formed of a magnetic material. Therefore, when the spin-torque oscillator does not sufficiently oscillate due to oscillation trouble or characteristic reduction, this spin-torque oscillator absorbs the recording magnetic field in the recording gap. As a result, in this type of recording head, the recording magnetic field applied to the recording medium is reduced compared to a normal recording head which does not comprise a spin-torque oscillator; in a normal recording head, the recording gap is an air gap which does not include a magnetic material.

### BRIEF DESCRIPTION OF THE DRAWINGS

FIG. 1 is a block diagram schematically showing a magnetic disk drive (HDD) according to a first embodiment;

FIG. 2 is a side view showing a magnetic head, a suspension and a recording medium in the HDD;

FIG. 3 is a schematic cross-sectional view in which a head portion of the magnetic head and a magnetic disk are partially enlarged;

FIG. 4 is a cross-sectional view in which a distal end portion of a recording head and a spin-torque oscillator (STO) are enlarged;

FIG. 5 is a plan view when the distal end portion of the recording head is viewed from an ABS side;

FIG. 6 is a diagram showing comparison of recording magnetic fields of (a) a magnetic head when an STO oscillates, (b) a magnetic head which comprises an STO when the STO does not oscillate, and (c) a magnetic head which does not comprise an STO;

FIG. 7 a diagram showing comparison of signal-to-noise ratios of signals recorded in a magnetic recording medium by the magnetic heads (a), (b) and (c) described above;

FIG. 8 is a flowchart showing an operation for inspecting and destroying the STO by an inspection circuit of the HDD;

FIG. 9 a diagram showing the relationship between driving current applied to the STO and resistance of the STO;

FIG. 10 is a cross-sectional view showing the STO which is physically and magnetically destroyed and the distal end portion of the recording head;

FIG. 11 is a plan view when the STO which is physically and magnetically destroyed and the distal end portion of the recording head are viewed from the ABS side;

FIG. 12 is a plan view schematically showing a head wafer in which many magnetic heads are formed according to a second embodiment;

FIG. 13 is a plan view in which a bar-shaped piece cut from the head wafer is enlarged;

FIG. 14 a diagram showing the relationship between the resistance of a spin-torque oscillator and magnetic field characteristics;

FIG. 15A, FIG. 15B and FIG. 15C are cross-sectional views schematically showing a process for forming a magnetic head and an STO, a process for disintegrating and destroying the STO and a process for forming an ABS; and

FIG. 16 is a perspective view showing the magnetic head manufactured by a manufacturing method according to the second embodiment.

### DETAILED DESCRIPTION

Various embodiments will be described hereinafter with reference to the accompanying drawings. In general, according to one embodiment, a recording head comprises a recording magnetic pole which applies a recording magnetic field, a write shield which faces the recording magnetic pole across a recording gap, and a spin-torque oscillator portion provided in the recording gap between the recording magnetic pole and the write shield, wherein the spin-torque oscillator portion is physically and/or magnetically destroyed and has resistance greater than or equal to a predetermined value.

### First Embodiment

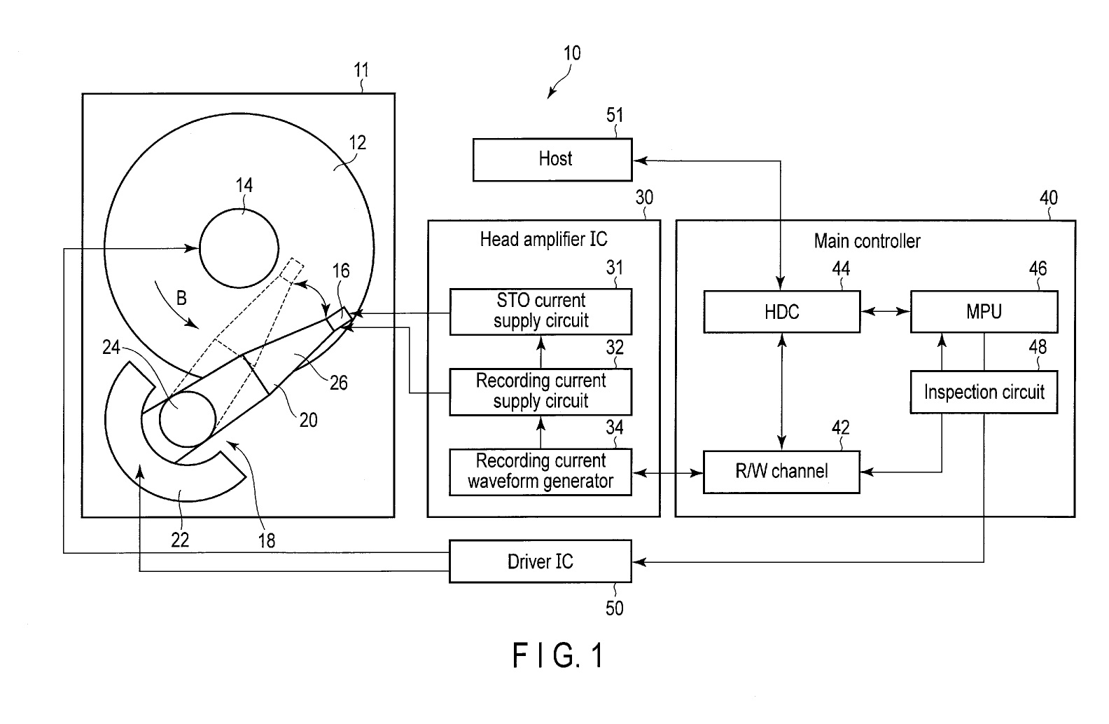

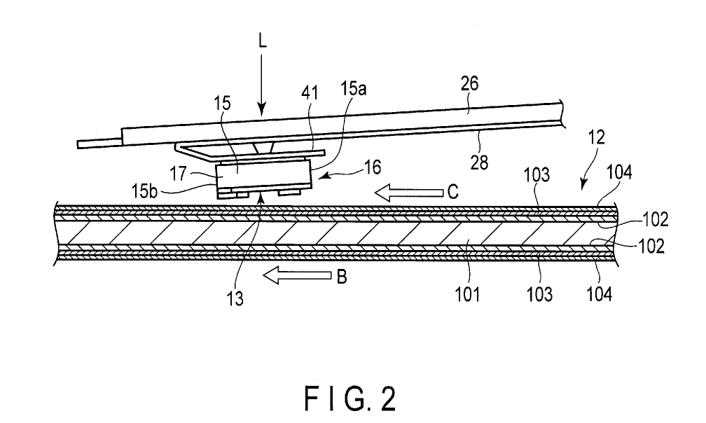

FIG. 1 is a block diagram schematically showing a hard disk drive (HDD) as a disk device according to a first embodiment. FIG. 2 is a side view showing a magnetic head in a flying state and a magnetic disk.

As shown in FIG. 1, an HDD 10 comprises a rectangular housing 11, a magnetic disk 12 as a recording medium provided in the housing 11, a spindle motor 14 which supports and rotates the magnetic disk 12, and a plurality of magnetic heads 16 which write and read data with respect to the magnetic disk 12.

The HDD 10 further comprises a head actuator 18 which moves the magnetic heads 16 onto an arbitrary track of the magnetic disk 12 and determines the position of the magnetic heads 16. The head actuator 18 includes a suspension assembly 20 which movably supports the magnetic heads 16, and a voice coil motor (VCM) 22 which rotates the suspension assembly 20.

The HDD 10 comprises a head amplifier IC 30 and a main controller 40. The head amplifier IC 30 is provided in, for example, the suspension assembly 20, and is electrically connected to the magnetic heads 16. The main controller 40 is constructed on, for example, a control circuit substrate (not shown) provided on the back surface of the housing 11. The main controller 40 comprises an R/W channel 42, a hard disk controller (HDC) 44, a microprocessor (MPU) 46, an inspection circuit 48 which inspects recording and reading characteristics of the magnetic heads 16, and a driver IC 50. The main controller 40 is electrically connected to the magnetic heads 16 via the head amplifier IC 30. The main controller 40 is electrically connected to the VCM 22 and the spindle motor 14 via the driver IC 50. The HDD 10 is connectable to a host computer 51.

As shown in FIG. 1 and FIG. 2, the magnetic disk 12 is structured as a perpendicular magnetic recording medium. For example, the magnetic disk 12 comprises a substrate 101 which is formed of a nonmagnetic material in the shape of a circular plate having a diameter of approximately 2.5 inches (6.35 cm). On each surface of the substrate 101, a soft magnetic layer 102 is formed as an underlayer. On the soft magnetic layer 102, a magnetic recording layer 103 and a protective film 104 are stacked in series. The magnetic disk 12 concentrically fits in the hub of the spindle motor 14. The magnetic disk 12 is rotated in the direction of an arrow B at a predetermined speed by the spindle motor 14.

The suspension assembly 20 comprises a bearing 24 which is rotatably attached to the housing 11, and a plurality of suspensions 26 which extend from the bearing 24. As shown in FIG. 2, the magnetic head 16 is supported by the extended end of each suspension 26. The magnetic head 16 is electrically connected to the head amplifier IC 30 via an interconnection member 28 provided on the suspension 26.

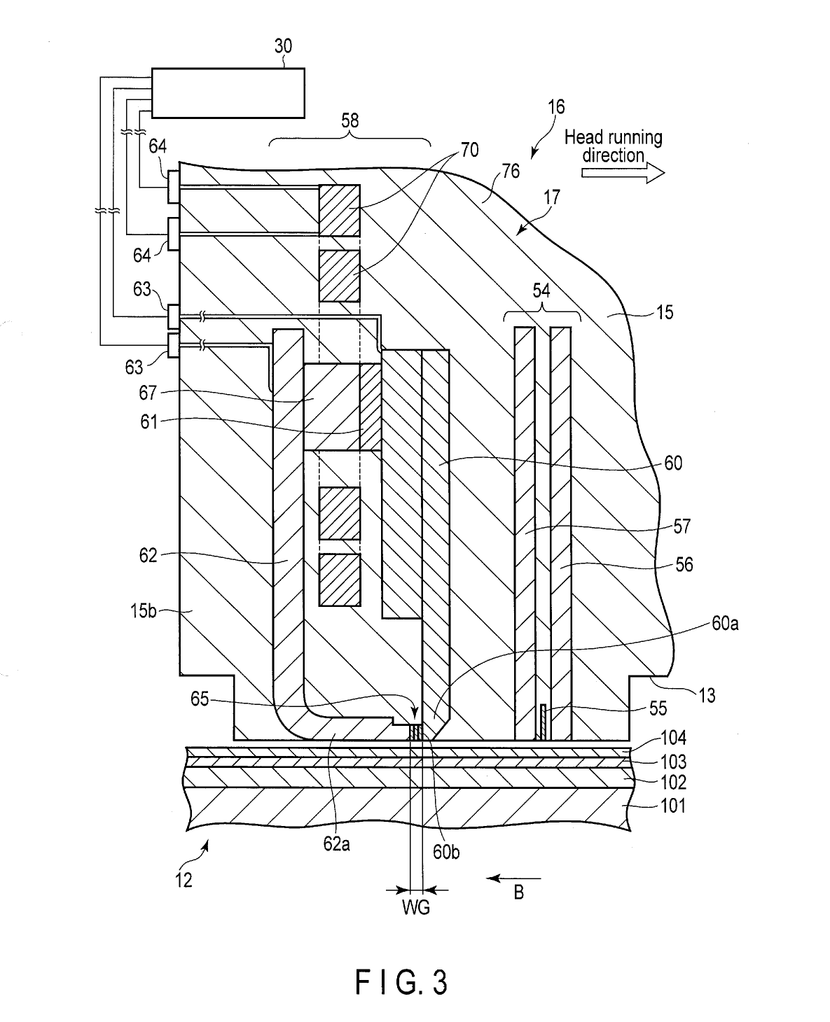

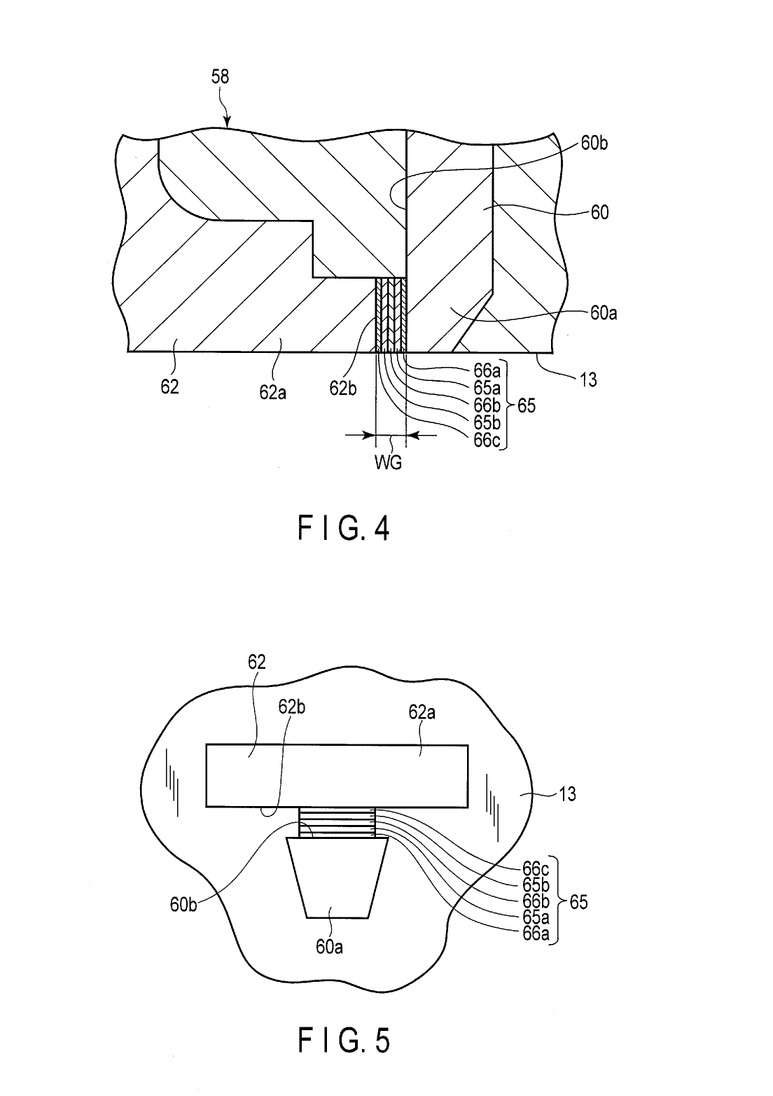

Now, the specification explains the structure of the magnetic head 16 in detail. FIG. 3 is an enlarged sectional view of the head portion of the magnetic head and the magnetic disk. FIG. 4 is an enlarged cross-sectional view showing the distal end portion of the recording head and the magnetic disk. FIG. 5 is a plan view of the distal end portion of the recording head viewed from the air bearing surface (ABS) side.

As shown in FIG. 2 and FIG. 3, the magnetic head 16 is structured as a flying head, and comprises a slider 15 formed in the shape of a substantially rectangular parallelepiped, and a head portion 17 formed in the end portion on the outflow end (trailing) side of the slider 15. For example, the slider 15 is formed of a sintered alumina-titanium carbide body (AlTiC). The head portion 17 is formed by a plurality of thin films of layers.

The slider 15 comprises a disk-facing surface (a medium-facing surface or an air bearing surface [ABS]) 13. The disk-facing surface 13 is rectangular and faces the surface of the magnetic disk 12. The slider 15 is maintained in a state where the slider 15 is floated with a predetermined amount from the magnetic disk surface by an aerial flow C generated between the disk surface and the ABS 13 by rotation of the magnetic disk 12. The direction of the aerial flow C conforms to the rotation direction B of the magnetic disk 12. The slider 15 comprises a reading end 15a positioned on the inflow side of the aerial flow C, and a trailing end 15b positioned on the outflow side of the aerial flow C.

As shown in FIG. 3, the head portion 17 comprises a reproduction head 54 formed by a thin-film process and a recording head 58 in the trailing end 15b of the slider 15. The head portion 17 is formed as a separation type of magnetic head. The head portion 17 comprises a spin-torque oscillator (STO) 65 as a microwave oscillator.

The reproduction head 54 comprises a magnetic film 55 having a magnetoresistive effect, and shield films 56 and 57 allocated on the trailing and reading sides of the magnetic film 55 so as to sandwich the magnetic film 55. The lower ends of the magnetic film 55 and the shield films 56 and 57 are exposed on the ABS 13 of the slider 15.

The recording head 58 is provided on the trailing end 15b side of the slider 15 relative to the reproduction head 54. The recording head 58 comprises a main magnetic pole (recording magnetic pole) 60, a write shield (trailing shield) 62 provided on the trailing side of the main magnetic pole 60 across a write gap WG, a connection portion 67 is a magnetic material, a recording coil 70, and a high-frequency oscillator such as the spin-torque oscillator 65. The main magnetic pole 60 is formed of a soft magnetic material having a high magnetic permeability and a high saturation magnetic flux density, and generates a recording magnetic field in a direction perpendicular to the surface (recording layer) of the magnetic disk 12. The write shield 62 is formed of a soft magnetic material, and is provided to efficiently close a flux path via the soft magnetic layer 102 positioned immediately under the main magnetic pole. An electronic insulating layer 61 is provided in the connection portion 67 connecting the main magnetic pole 60 and the write shield 62. The main magnetic pole 60 is electrically insulated from the write shield 62. The STO 65 is provided in a portion facing the ABS 13 between a distal end portion 60a of the main magnetic pole 60 and the write shield 62 and applies a high-frequency magnetic field (microwave) to the recording layer of the magnetic disk 12.

The recording coil 70 is provided so as to wind around a magnetic circuit (core) including the main magnetic pole 60 and the write shield 62. In the present embodiment, for example, the recording coil 70 winds around the connection portion 67 between the main magnetic pole 60 and the write shield 62. The recoding coil 70 is connected to a write current terminal 64 provided in the trailing end 15b of the slider 15. The write current terminals 64 are connected to the head amplifier IC 30 via interconnections. When data is written to the magnetic disk 12, recoding current is supplied to the recording coil 70. The recording coil 70 excites the main magnetic pole 60 and supplies a magnetic flux to the main magnetic pole 60. The recording current supplied to the recording coil 70 is controlled by the head amplifier IC 30 and the main controller 40.

As shown in FIG. 3, FIG. 4 and FIG. 5, the main magnetic pole 60 extends substantially perpendicularly to the surface of the magnetic disk 12. The distal end portion 60a of the main magnetic pole 60 on the ABS 13 side tapers toward the disk surface. The distal end portion 60a of the main magnetic pole 60 has, for example, a trapezoidal cross-sectional surface. The distal end surface of the main magnetic pole 60 is exposed on the ABS 13 of the slider 15. The width of a trailing-side end surface 60b of the distal end portion 60a substantially corresponds to the width of the track of the magnetic disk 12.

The write shield 62 is formed in a substantially L-shape. Its distal end portion 62a is formed in the shape of a slender rectangle. The distal end surface of the write shield magnetic pole 62 is exposed on the ABS 13 of the slider 15. The distal end portion 62a of the write shield 62 comprises a leading-side end surface (magnetic pole end surface) 62b facing the distal end portion 60a of the main magnetic pole 60. The leading-side end surface 62b is sufficiently longer than the width of the distal end portion 60a of the main magnetic pole 60 and the track width of the magnetic disk 12 and extends along the track width of the magnetic disk 12. On the ABS 13, the leading-side end surface 62b faces the trailing-side end surface 60b of the main magnetic pole 60 in parallel across the write gap WG.

The spin-torque oscillator (STO) 65 is provided between the distal end portion 60a of the main magnetic pole 60 and the leading-side end surface 62b of the write shield 62 near the ABS 13. The STO 65 is allocated in the write gap WG. In the present embodiment, the STO 65 is structured by stacking an underlayer (conductive metal layer) 66a, a spin injection layer (SIL) (second magnetic layer) 65a, an intermediate layer (conductive metal layer) 66b, an Field Generating layer (FGL: Oscillation layer) (first magnetic layer) 65b and a cap layer (conductive metal layer) 66c in order from the main magnetic pole 60 side to the write shield 62 side. This stacking order can be reversed.

The width of the STO 65 (in other words, the width in the track width direction) is substantially equal to or slightly less than that of the distal end portion 60a of the main magnetic pole 60. The STO 65 aligns relative to the main magnetic pole so as to face the whole distal end portion 60a of the main magnetic pole.

The underlayer 66a is formed by a monolayer film or a laminated film containing a conductive material such as Ta and Cu. The spin injection layer 65a is formed by alloy or a laminated film containing Co, Pt and the like, or a laminated film containing Fe, Co, Ni and the like. The intermediate layer 66b contains a conductive material such as Cu. The oscillation layer 65b is formed by alloy or a laminated film containing Fe, Co, Ni and the like. The cap layer 66c is formed by a monolayer or a laminated film containing Ta, Ru and the like.

The underlayer 66a is joined to the trailing-side end surface 60b of the main magnetic pole 60 and is electrically connected to the main magnetic pole 60. The cap layer 66c is joined to the reading-side end surface 62b of the write shield and is electrically connected to the write shield 62. The write shield 62 and the main magnetic pole 60 also function as an electrode for perpendicular conduction to the spin-torque oscillator 65.

The main magnetic pole 60 and the write shield 62 are electrically connected to the respective electrode terminals 63 provided in the trailing end 15b of the slider 15. These electrode terminals 63 are connected to the head amplifier IC 30 via interconnections. In this manner, a current circuit is structured so as to distribute STO driving current from the head amplifier IC 30 to the main magnetic pole 60, the STO 65 and the write shield 62 in series. The power distribution to the STO 65 is controlled by the head amplifier IC 30 and the main controller 40.

As shown in FIG. 3, the reproduction head 54 and the recording head 58 are covered by an insulating material 76 except for the portion exposed on the ABS 13 of the slider 15. The insulating material 76 forms the outer shape of the head portion 17.

As shown in FIG. 1, the head amplifier IC 30 driving the magnetic head 16 having the above structure comprises a recording current supply circuit 32 which supplies recording current to the recording coil 70 via the interconnection member 28 and the write current terminal 64, an STO current supply circuit 31 which supplies driving current to the STO 65 via the interconnection member 28 and the electrode terminal 63, and a recording current waveform generator 34 which generates a recording current waveform in accordance with a recording pattern signal generated in the R/W channel 42.

When the HDD 10 is operated, the main controller 40 drives the spindle motor 14 by the driver IC 50 under control of the MPU 46 and rotates the magnetic disk 12 at a predetermined speed. The main controller 40 drives the VCM 22 by the driver IC 50, moves the magnetic head 16 onto a desired track of the magnetic disk 12 and determines the position of the magnetic head 16.

At the time of recording, the recording current supply circuit 32 of the head amplifier IC 30 distributes recording current to the recording coil 70 in accordance with the recording signal and recording pattern generated by the R/W channel 42. In this manner, the recording coil 70 excites the main magnetic pole 60 and generates a recording magnetic field from the main magnetic pole 60.

The STO current supply circuit 31 distributes driving current in series through the interconnection member 28, the electrode terminal 63, the main magnetic pole 60, the STO 65 and the write shield 62 by applying voltage to the main magnetic pole 60 and the write shield 62 under control of the MPU 46. In short, the STO current supply circuit 31 distributes current in the direction of the film thickness of the STO 65. By this distribution, the magnetization of the oscillation layer 65b of the STO 65 is rotated. Thus, a high-frequency magnetic field (microwave) can be generated. The STO 65 applies a high-frequency magnetic field to the magnetic recording layer 103 of the magnetic disk 12 and reduces the coercive force of the magnetic recording layer 103. In this state, the recording magnetic field is applied to the magnetic recording layer 103 from the recording head 58, and desired data is written to the magnetic recording layer 103. In this manner, the recording head 58 can record data in a recording medium which has a high magnetic anisotropy.

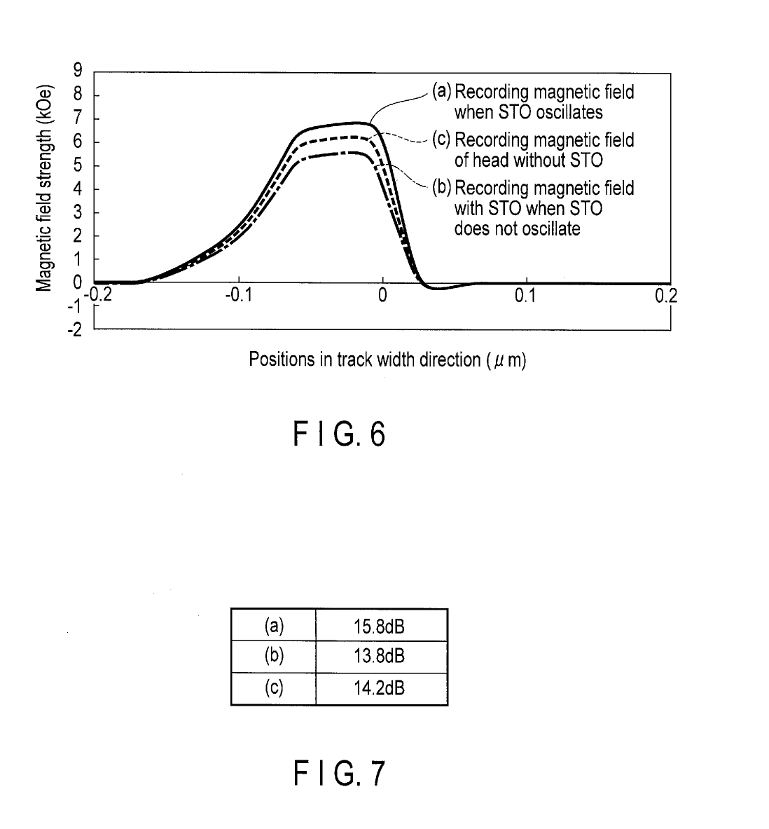

FIG. 6 shows comparison of effective recording magnetic field distributions (magnetic field strengths) in positions in the direction of the track width of a magnetic disk with respect to (a) a recording head when an STO oscillates, (b) a recording head which comprises an STO when the STO does not oscillate and (c) a recording head which does not comprise an STO in a recording gap. FIG. 7 shows comparison of signal-to-noise ratios of signals recorded in a magnetic recording medium by the recording heads (a), (b) and (c). Only spin-torque oscillators showing good oscillation are selected for experiment.

As shown in FIG. 6 and FIG. 7, in the recording head (a) in which the STO oscillates at a high frequency, the magnetic permeability around the STO is substantially the same as the air gap (recording gap) relative to the recording magnetic field response. Thus, the recording magnetic field is not decreased in the recording medium. The recording head (a) shows the best signal-to-noise ratio.

In the recording heads (b) and (c) which do not have STO oscillation assist, the effective magnetic field strength is decreased more than that in the recording head (a). Between the recording heads (b) and (c), the signal-to-noise ratio of recorded signals is different. The signal-to-noise ratio of the recording head (c) is higher than that of the recording head (b).

The STO is formed of a magnetic material. Therefore, in the case of the recording head (b) in which the STO does not oscillate, the STO absorbs the recording magnetic field in the recording gap. In this manner, the recording magnetic field applied to the recording medium is more decreased in the recording head (b) than in the normal recording head (c) which does not include a magnetic material in the recording gap.

When a recording head showing a high signal-to-noise ratio is used in combination with a recording medium in a magnetic recording device, the magnetic recording device can realize a large recording capacity and have high reliability. Now, this specification assumes a case where STO oscillation characteristics are not uniform and some STOs are defective and do not oscillate in the actual product. In a recording head in which the STO does not oscillate, the magnetic recording characteristics are reduced compared to a recording head in which the STO oscillates. However, for example, if the recording capacity of the recording medium is relaxed, the recording head in which the STO does not oscillate can be used. In this case, decrease in the recording performance should be preferably minimized.

As shown in FIG. 7, the signal-to-noise ratio indicated as (b) can be obtained by a recording head in which the STO does not oscillate. The performance of a group of these recording heads is preferably increased to (c). Specifically, it is possible to obtain the characteristics of the recording head (c) which does not comprise an STO by losing the magnetic portion of the STO when the recording head is manufactured or after the recording head is mounted on the HDD.

In the present embodiment, the HDD 10 comprises the inspection circuit 48 which inspects the oscillation characteristics of the STO 65. When or after the HDD is shipped, the inspection circuit 48 inspects the oscillation characteristics of the STO 65 at intervals of certain periods of use. Specifically, in the inspection, the oscillation characteristics may be determined by monitoring the resistance of the STO 65 or monitoring the resistance-change frequency (which is equivalent to the oscillation frequency). Alternatively, the oscillation characteristics may be inspected by monitoring change in the error rate when data is recorded and reproduced and determining whether or not the error rate is within a desired range of data error rate. In the former case, a circuit resistance detector or a frequency detector can be provided as the inspection circuit. In the latter case, the normal R/W channel 42 can be also used as the inspection circuit. If a defective STO 65 is detected through the inspection of oscillation characteristics, excessive current is applied to the STO 65 by using the STO current supply circuit 32, thereby physically and/or magnetically destroying the STO 65.

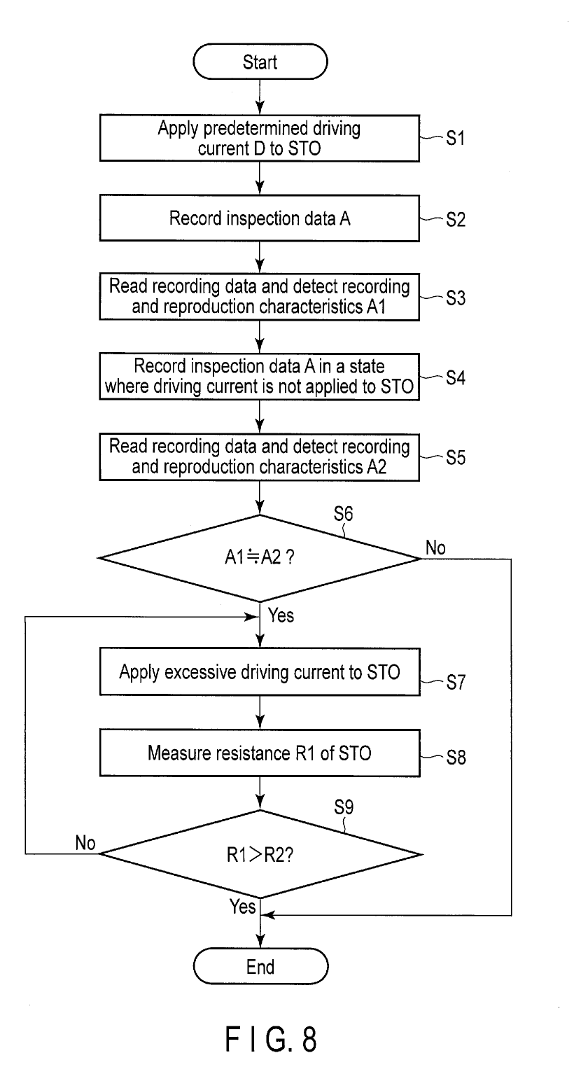

In the present embodiment, the oscillation characteristics of the STO 65, here, the recording and reproduction characteristics of the magnetic head 16, are inspected regardless of whether the STO 65 is good or defective before the HDD is shipped after the magnetic head 16 is mounted on the HDD. As shown in FIG. 8, the inspection circuit 48 of the HDD 10 applies a predetermined driving current (bias current) D to the STO 65 via the head amplifier IC 30 in order to oscillate the STO 65 (S1). In this state, the inspection circuit 48 writes inspection data A to the magnetic disk 12 by using the recording head 58 (S2). The inspection circuit 48 reads the written inspection data by using the magnetic head 16 and detects recording and reproduction characteristics A1 (S3). In this case, the R/W channel 42 is employed to detect the recording and reproduction characteristics.

Subsequently, the inspection circuit 48 writes inspection data A to the magnetic disk 12 by using the recording head 58 in a state where driving current is not applied to the STO 65 (S4). The inspection circuit 48 reads the written inspection data by using the magnetic head 16 and detects recording and reproduction characteristics A2 (S5). The inspection circuit 48 compares the detected recording and reproduction characteristics A1 and A2 (S6). If the recording and reproduction characteristics A1 and A2 differ greatly, the inspection circuit 48 determines that the STO 65 is a good product which normally oscillates at a high frequency. The inspection circuit 48 terminates the inspection.

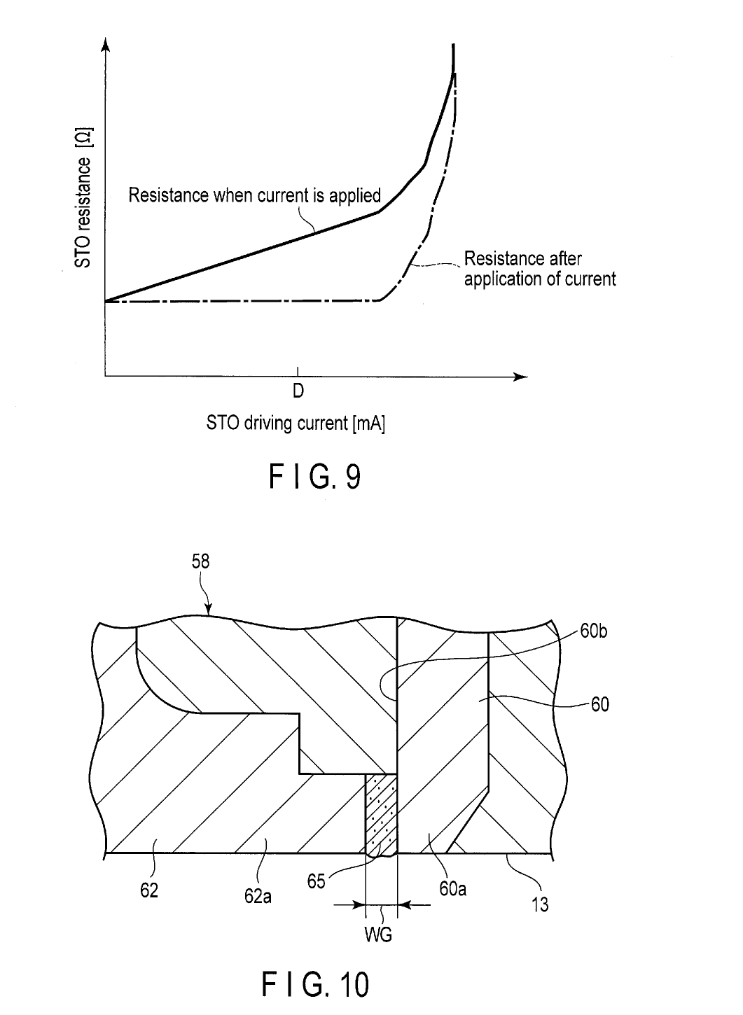

If the difference between the recording and reproduction characteristics A1 and A2 is very little, the inspection circuit 48 determines that the STO 65 is defective (in oscillation) with respect to the magnetic head 16. In other words, the inspection circuit 48 determines that the STO 65 does not normally oscillate at a high frequency. In this case, the inspection circuit 48 applies driving current excessively larger than the predetermined driving current D to the recording head 58 comprising the defective STO. For example, as shown in FIG. 9, the element resistance of the STO 65 is steadily and reversibly increased by the Joule heat generated by application of driving current. When driving current is further increased, the resistance of the STO 65 is unsteadily changed and never returns to the previous state because the STO 65 which is a microscopic element having a diameter of several tens of nanometers is disintegrated and destroyed by the Joule heat generated by driving current. For example, the resistance of the STO 65 is 25 to 65 Q before destruction. After disintegration and destruction, the resistance of the STO 65 is increased to more than the initial value; to 100 Q to infinity.

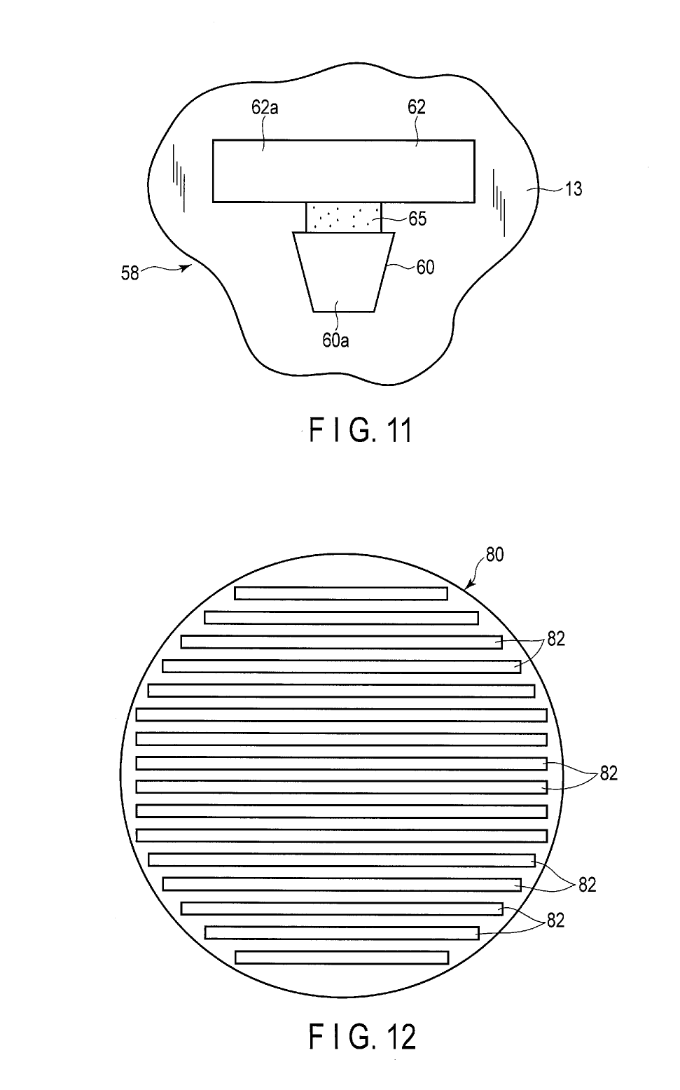

FIG. 10 and FIG. 11 show the recording head 58 around the STO after disintegration and destruction. The magnetic layers and the conductive metal layers constituting the STO 65 are disintegrated and mixed. The laminated structure of the STO is destroyed and is changed to a mixed structure. In this manner, the STO 65 is physically and magnetically destroyed by disintegrating and mixing the plurality of layers of the STO 65. By disintegrating and mixing the magnetic layers and the conductive metal layers, the STO 65 is changed to a metal mixture having a weak magnetization of 100 emu/cc or less. The resistance of the STO 65 is changed to 100 Q or greater and thus, is higher than the resistance before disintegration and destruction.

As shown in FIG. 8, the inspection circuit 48 detects resistance R1 of the STO 65 (S8) and determines whether or not resistance R1 after application of excessive current is greater than the predetermined resistance R2 (S9). The inspection circuit 48 increases the driving current applied to the STO 65 until R1>R2. When the detected resistance R1 is greater than the predetermined resistance R2, the inspection circuit 48 determines that the STO 65 has been disintegrated and destroyed, stops applying driving current to the STO 65 and terminates the inspection.

By the disintegration with excessive driving current, the STO is physically and magnetically destroyed and lost. In this manner, the recording magnetic field strength of the recording head 58 can be recovered to a value substantially equal to that of a recording head which does not comprise an STO. When the destroying and losing process of the present embodiment was applied to a magnetic head which had been determined as having a detective STO in oscillation, the average recording capacity of the HDD was improved by approximately 10% compared to before the application of the process.

When the STO 65 is disintegrated and destroyed as described above, the recording capacity of the magnetic disk 12 is decreased compared to an HDD comprising a good STO. Therefore, in the present embodiment, an HDD in which the STO 65 has been disintegrated and destroyed is shipped as an HDD having a recording capacity less than an HDD comprising a good STO. The above inspection of the STO 65 may be performed at intervals of predetermined periods of use after shipment.

As explained above, the HDD of the present embodiment comprises a magnetic recording head comprising a spin-torque oscillator near a main magnetic pole. The HDD may use microwave-assisted recording or may not use microwave-assisted recording depending on variation or defectiveness of oscillation characteristics of the spin-torque oscillator. When microwave-assisted recording is not used; in other words, when recording is performed without distributing power to the spin-torque oscillator, the magnetization of the oscillation layer of the spin-torque oscillator is lost or removed in advance, and then, the recording head is used as a magnetic recording head. Thus, the recording head can maintain the recording performance substantially equivalent to a recording head which does not comprise an STO.

In the present embodiment, it is possible to provide a recording head which is allowed to selectively use a microwave-assisted recording head comprising a spin torque oscillator depending on the characteristics, and a magnetic recording device comprising the recording head.

Now, this specification explains a magnetic head of an HDD of another embodiment, and a method for manufacturing the magnetic head. In the embodiment explained below, the structural elements identical to those of the first embodiment are denoted by the same reference numbers or symbols. Thus, detailed explanations of such elements are omitted. In the embodiment below, structural elements different from those of the first embodiment are mainly explained in detail.

### Second Embodiment

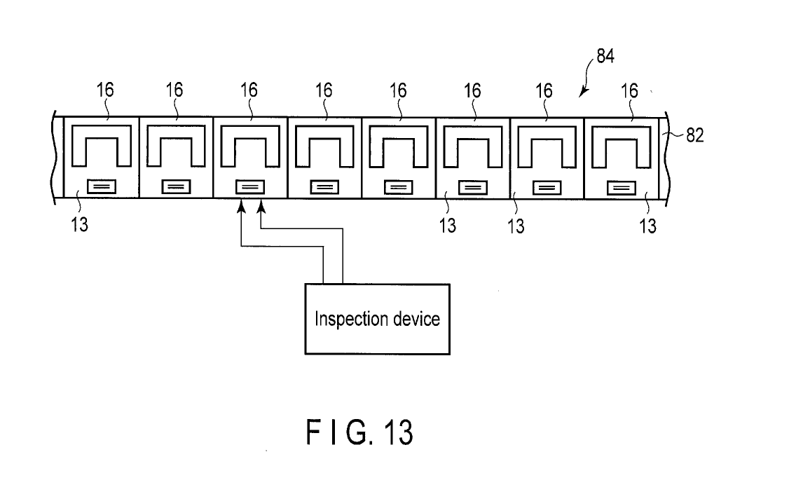

FIG. 12 is a plan view showing a head wafer in which many magnetic heads are formed by stacking thin films. FIG. 13 is a plan view in which a bar-shaped piece cut from the head wafer is enlarged.

As shown in FIG. 12, in a magnetic head manufacturing process, many magnetic heads each comprising a slider, a reproduction head, a recording head and an STO are continuously arranged in a plurality of lines 82 on a head wafer 80 by a thin-film lamination process. Each magnetic head is structured in the same manner as the magnetic head 16 of the first embodiment. As shown in FIG. 13, the magnetic heads of the lines 82 are cut from the head wafer 80 and are separated into a plurality of bar-shaped pieces 84 each including continuous magnetic heads 16.

Subsequently, an inspection device 86 inspects oscillation defectiveness of the spin-torque oscillator of each recording head of the bar-shaped pieces 84. For example, the inspection device 86 monitors resistance change or resistance-change frequency by power distribution to the spin-torque oscillator. The inspection device 86 comes in contact with the STO distribution terminal of each recording head through pins and has a function for distributing power to the STO and a function for detecting the STO resistance.

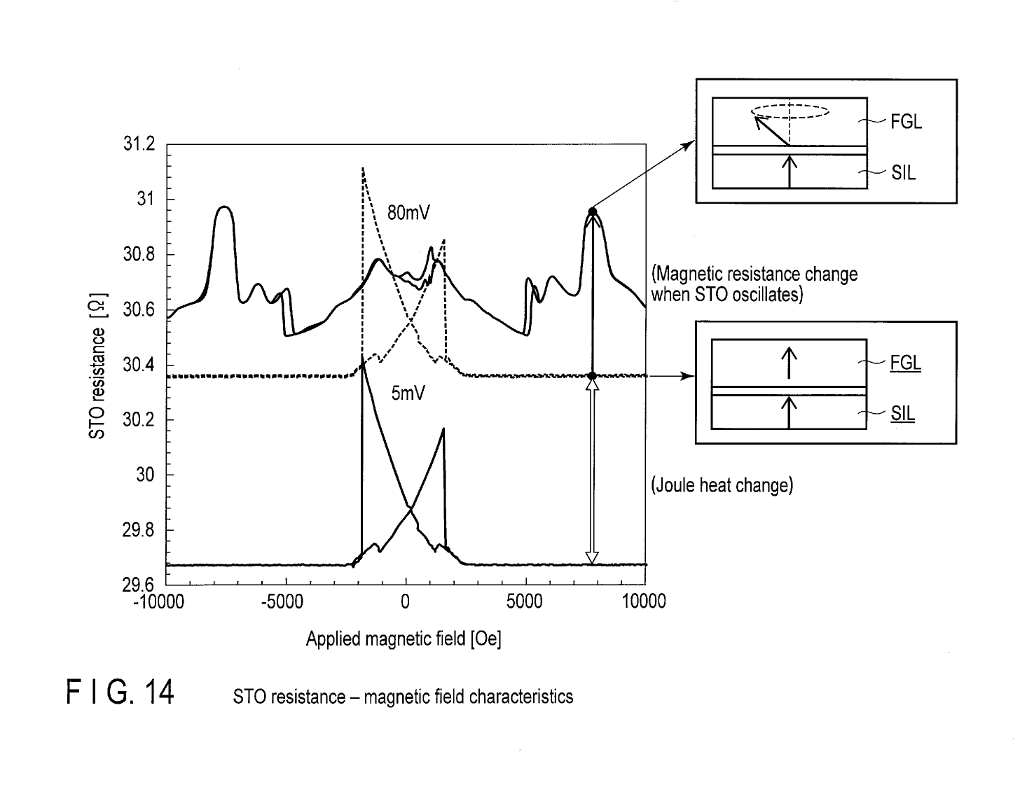

FIG. 14 shows the magnetic resistance change when the spin-torque oscillator (STO) oscillates. A good STO oscillates when certain current is applied in a state where a magnetic field is applied from outside. At this time, the magnetized angle between magnetic films in the STO is changed by oscillation. Therefore, the magnetic resistance of the STO is changed. A magnetic field may be applied to the STO from outside of the bar-shaped piece 84 by a magnetic field generator. Alternatively, the magnetic field generated in the recording gap in which the STO is present due to application of current to the recording head may be applied to the STO.

The magnetization of an oscillation layer (FGL) 65b of the STO is rotated in accordance with the oscillation frequency. In connection with the rotation, the resistance frequency is changed by approximately 15 to 30 GHz in synchronization with the oscillation frequency. It is possible to inspect whether or not the STO generates good oscillation by monitoring the magnetic resistance change and the resistance frequency change. When the inspection device 86 detects oscillation defectiveness from the STO, the inspection device 86 applies excessive driving current (bias current) to the STO compared to a normal case in order to disintegrate and destroy the STO.

After all of the magnetic heads 16 have been inspected, an ABS pattern for ensuring floating characteristics is formed by lapping the surface to be an air bearing surface (ABS) 13 and etching and polishing the surface.

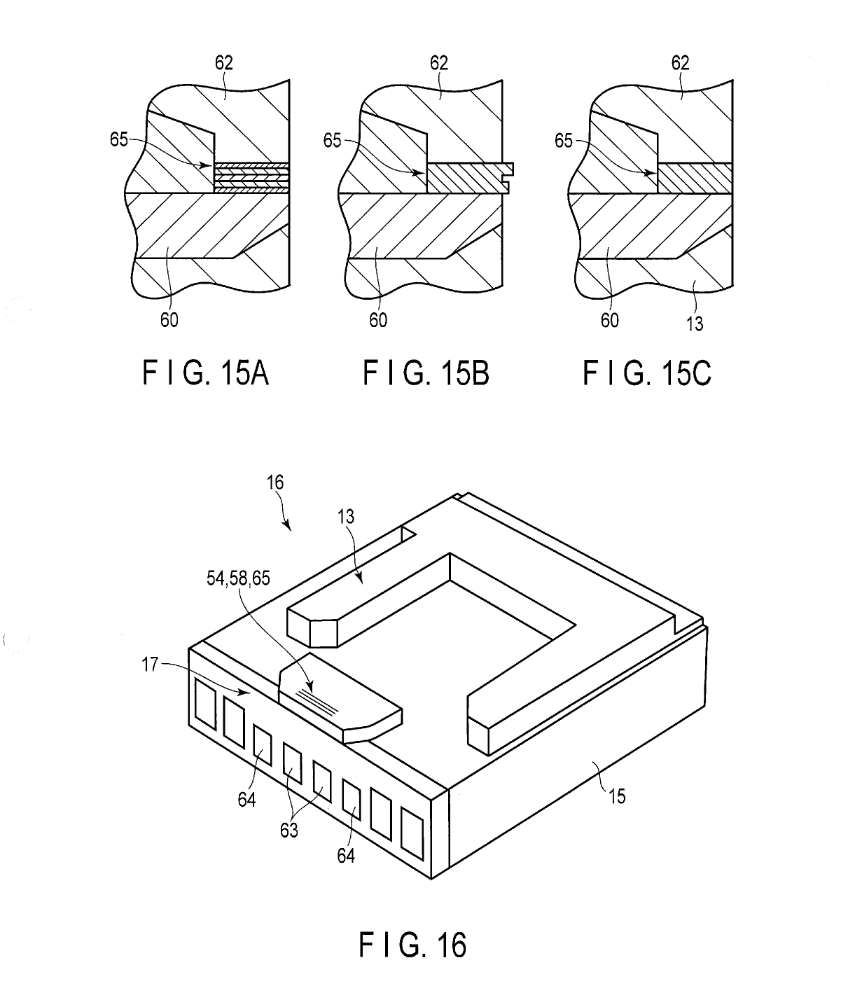

As shown in FIG. 15A and FIG. 15B, when the spin-torque oscillator is disintegrated and destroyed, the disintegrated oscillator portion may project from the head surface and become a projection. As shown in FIG. 15C, the projection can be removed by lapping and patterning the ABS after the spin-torque oscillator 65 is disintegrated and destroyed. In this manner, the head surface can be smoothed.

Subsequently, the bar-shaped pieces 84 in which the ABS pattern is formed are divided into the respective magnetic heads 16. In this manner, many magnetic heads 16 each having the structure shown in FIG. 16 can be obtained.

By means of the manufacturing method of the above embodiment, it is possible to manufacture a recording head and a magnetic head having good recording characteristics both when the spin-torque oscillator is used in an on-state and when it is used in an off-state. In other words, it is possible to obtain a recording head manufacturing method which allows selective use of a microwave-assisted recording head comprising a spin-torque oscillator depending on the characteristics. In addition, it is possible to remove the projection of a spin-torque oscillator due to disintegration and obtain a smooth head surface by applying an ABS process after inspection, disintegration and destruction of the oscillator.

The present invention is not limited to the above-described embodiments, but may be realized by modifying structural elements without departing from the scope. Various inventions can be realized by appropriately combining the structural elements disclosed in the embodiments. For instance, some of the disclosed structural elements may be deleted. Some structural elements of different embodiments may be combined appropriately.

For example, the spin-torque oscillator may not be provided on the trailing side of the main magnetic pole, and may be provided on the reading side of the main magnetic pole. In the above embodiments, the spin-torque oscillator is magnetically and physically destroyed by disintegrating and mixing the magnetic layers and the conductive metal layers of the spin-torque oscillator. However, the spin-torque oscillator may be magnetically destroyed by applying doping of excessive oxygen and nitrogen to the magnetic layer portion of the spin-torque oscillator and reducing the magnetization of the magnetic layer.

What is claimed is:

1. A method of manufacturing a recording head comprising:
forming a recording head on a head wafer, the recording head comprising a recording magnetic pole, a write shield which faces the recording magnetic pole across a recording gap, and a spin-torque oscillator provided in the recording gap between the recording magnetic pole and the write shield;
inspecting oscillation defectiveness of the spin-torque oscillator; and
physically and/or magnetically destroying, with respect to the recording head comprising the spin-torque oscillator having the oscillation defectiveness, the spin-torque oscillator by applying driving current excessively larger than driving current of a normal operation to the spin-torque oscillator.

2. The method of claim 1, which further comprises processing the recording head to have an air bearing surface after the inspecting and destroying.

3. The method of claim 1, wherein the forming includes stacking a plurality of magnetic layers and conductive metal layers to form the spin-torque oscillator, and
the destroying includes applying excessive driving current to the spin-torque oscillator and integrating and mixing the magnetic layers and the conductive metal layers.

4. The method of claim 1, wherein the forming includes stacking a plurality of magnetic layers and conductive metal layers to form the spin-torque oscillator, and
the destroying includes applying doping of oxygen or nitrogen to the spin-torque oscillator to magnetically destroy the spin-torque oscillator.
